(19) United States
(12) Patent Application Publication
(10) Pub. No.: US 2009/0244633 A1
(43) Pub. Date: Oct. 1, 2009

(54) Systems and Methods for Color Data Compression

(75) Inventor: Peter Johnston, San Francisco, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/242,632

(22) Filed: Sep. 30, 2008

Related U.S. Application Data
(63) Continuation-in-part of application No. 12/078,415, filed on Mar. 31, 2008.
Application No. 12/078,415 is a continuation-in-part of application No. 12/078,417, filed on Mar. 31, 2008.

(51) Int. Cl. G06K 15/00

(52) U.S. Cl. 358/3.23

(57) ABSTRACT

Systems and methods are provided for reducing data size of at least one bitmap image using a look-up table, wherein the look-up table stores information correlating a plurality of compression ratios to a set of compression parameters and wherein the bitmap image comprises a plurality of image components, each image component associated with a distinct color plane. The plurality of color planes may be ranked using a dominance rank, wherein the dominance rank for a color plane is based on image component data associated with the color plane. At least one compression ratio may be associated with each color plane based on the dominance rank associated with the color plane. At least one image component may be compressed according to the compression ratio associated with the color plane corresponding to the image component using compression parameters obtained from the look-up table. The compression ratio may be iteratively adjusted, until the total data size of the plurality of image components is below a data size threshold.

### CROSS REFERENCES TO RELATED APPLICATIONS

This application is a continuation-in-part of commonly-assigned, co-pending applications, U.S. patent application Ser. No. 12/078,415 (inventor: Peter Johnston) filed Mar. 31, 2008, entitled “System and Method for Resolution Switching” (Attorney Docket No. 9546.0054-00); and U.S. patent application Ser. No. 12/078,417 (inventors: Isao Hayami and Peter Johnston) filed Mar. 31, 2008, entitled “System and Method for Color Data Compression” (Attorney Docket No. 9546.0066-00). The above-mentioned applications are hereby incorporated by reference into this application in their entirety for all purposes.

### TECHNICAL FIELD

This disclosure relates to data compression for printing systems and in particular, to systems and methods for color data compression on laser printers.

### DESCRIPTION OF RELATED ART

A typical printing system may include a print engine that controls various mechanical and electrical parts configured to print data on a page at a predetermined print speed. The print engine is usually controlled by a print controller, which communicates with a print data input device (e.g., a personal computer) and the print engine, to coordinate timing and other parameters related to the printing process. The print controller may receive image data for printing from the input device at an appropriate rate via a data transferring interface, can generate rasterized images, and send them to the print engine for printing.

Some printing systems, such as laser printing systems, may have hard real time requirements so that once a print job has been initiated, data transfers to the print engine occur at a set speed without interruption. However, the bandwidth of the data transferring interface sometimes may not be sufficient to sustain the print speed. For instance, a page containing high resolution images may have a large data size even after image compression. When such a page is being transferred to the print controller from a print data input device at the print speed, the image data may exceed the bandwidth for some time period. As a result, the page for printing may not be completely transmitted to the print controller and print engine before the physical printing starts resulting in a data under-run. Consequently, the page may not be printed properly. The performance of the printing system may therefore be significantly compromised.

Conventionally, the printer controller may include a page buffer capable of buffering an entire page before printing commences. This may allow for some flexibility in how the print data is transferred to the print controller from the print data input device. For example, in order to store a full page of print data including high resolution images, the print controller may use a large amount of additional memory for both code and data storage. This may add substantial cost to the printing system. In addition, memory cannot typically be added by users to many existing printers, so an approach using additional memory will not help printers already on the market. Therefore, there is a need for systems and methods that provide a reliable printing solution that can be implemented for existing printers and that obviates the need for additional memory in the print engine.

### SUMMARY

In accordance with the present invention, systems and methods are provided for reducing data size of at least one bitmap image using a look-up table, wherein the look-up table stores information correlating a plurality of compression ratios to a set of compression parameters and wherein the bitmap image comprises a plurality of image components, each image component associated with a distinct color plane. The plurality of color planes may be ranked using a dominance rank, wherein the dominance rank for a color plane is based on image component data associated with the color plane. At least one compression ratio may be associated with each color plane based on the dominance rank associated with the color plane. At least one image component may be compressed according to the compression ratio associated with the color plane corresponding to the image component using compression parameters obtained from the look-up table. The compression ratio may be iteratively adjusted, until the total data size of the plurality of image components is below a data size threshold.

Embodiments of the present invention also relate to software, firmware, and program instructions created, stored, accessed, or modified by processors using computer-readable media or computer-readable memory. The methods described may be performed on a computer and/or a printing device.

Additional objects and advantages will be set forth in part in the description, which follows, and in part will be obvious from the description, or may be learned by practice. The objects and advantages will be realized and attained by means of the elements and combinations particularly pointed out in the appended claims. It is to be understood that both the foregoing general description and the following detailed description are exemplary and explanatory only and are not restrictive of the invention, as claimed. These and other embodiments are further explained below with respect to the following figures.

### BRIEF DESCRIPTION OF THE DRAWINGS

FIG. 1 shows a block diagram of an exemplary printer.

FIG. 2 shows a block diagram indicating an exemplary data flow between an exemplary computer and an exemplary printer for color data compression.

FIG. 3 is a flow chart of an exemplary operation process for color data resolution and compression ratio switching.

FIG. 4A is a flow chart of an exemplary operation process for determining reduced resolution of FIG. 3.

FIG. 4B is a flow chart of an exemplary operation process for determining compression parameters of FIG. 3.

### DETAILED DESCRIPTION

Reference will now be made in detail to various embodiments, which are illustrated in the accompanying drawings. Wherever possible, the same reference numbers will be used throughout the drawings to refer to the same or like parts.

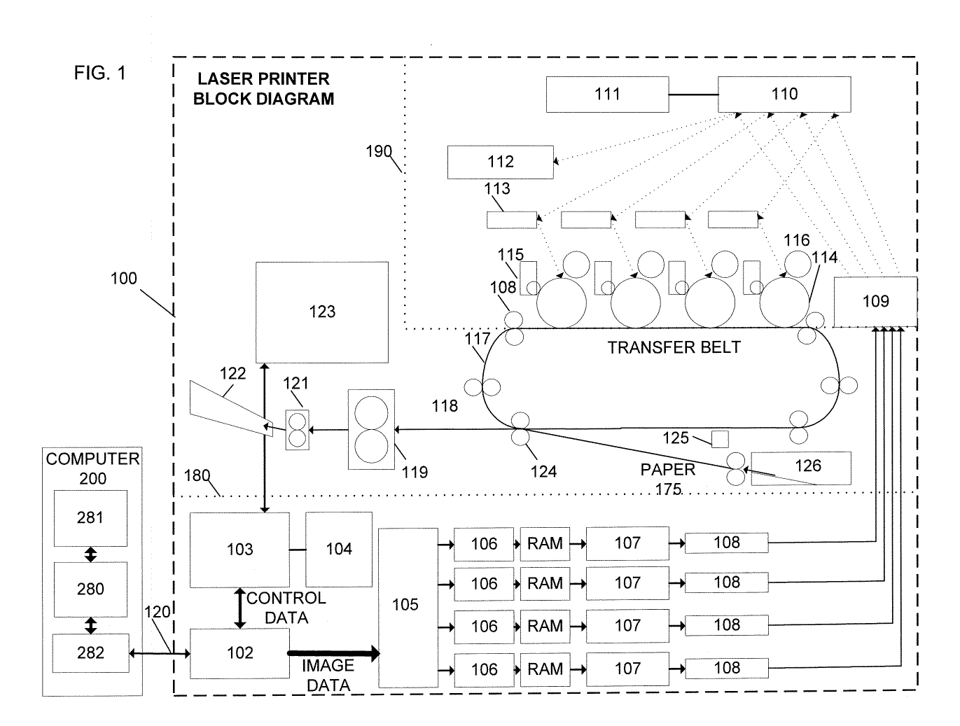

FIG. 1 is a block diagram of exemplary printer 100, which is coupled to exemplary computer 200. In some embodiments, printer 100 may be a laser printer, an LED printer, or any other printer consistent with principles of the present invention. Connection 120 couples computer 200 and printer 100 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, FIREWIRE and/or serial or parallel ports for transmission of data through appropriate connection 120. The communication links could be wireless links or wired links or any combination consistent with embodiments of the present invention that allows communication between computing device 200 and printer 100.

In some embodiments, connection 120 may operate at a predetermined data transferring frequency, or may otherwise have limited bandwidth. For example, connection 120 may operate at a determined frequency of 480 MHz and the corresponding maximum raw bandwidth may be 60 M bytes per second. In some embodiments, the maximum transfer rate of raw data may be lower than the maximum raw bandwidth due to encoding and protocol overhead. Under some exemplary protocols, an isochronous mode of transfer may be supported so that a certain amount of bandwidth may be reserved and data delivery at a corresponding transfer rate may be guaranteed. When the guaranteed transfer rate is lower than the rate at which the print engine consumes image data (i.e., print speed), data under-runs may occur on printer 100.

In some embodiments, the bandwidth of connection 120 may be divided into a plurality of sub-channels, and certain amounts of bandwidth may be reserved for each channel and data delivery at a corresponding transfer rate may be guaranteed for each channel. Data may be transferred via the plurality of sub-channels in a parallel manner. For example, for CMYK color printers, which use cyan (“C”), magenta (“M”), yellow (“Y”), and black (“K”), the print color data may have four planes, and data for each color plane may be transferred via a separate sub-channel of connection 12. In some embodiments, a same bandwidth may be reserved for each sub-channel. In some embodiments, various bandwidths may be reserved for different sub-channels.

In one exemplary embodiment, a USB interface 102 may be used as an interface to receive data via a serial pipe. It is contemplated that other interfaces may be used to receive data via other types of connection 120, such as, for example, FIREWIRE or wireless. Data received by USB interface 102 may be routed internally along internal data paths or data and control signal paths, such as a data bus, to various internal functional modules of printer 100 as determined by control logic in printer 100. In some embodiments, data transmitted to printer 100 by computer 200 may also include destination addresses and/or commands to facilitate routing.

In some embodiments, CPU 103, memory 104, control block 105, de-compressor module 106 with attached RAM, PWM logic module 107, and driver circuit 108 may be coupled using the data bus. Data received by USB interface 102 may be placed in memory 104 under the control of the CPU 103 according to some embodiments of the present invention. De-compressor 106 and attached RAM may also be coupled to PWM logic module 107. In some embodiments, de-compressor module 106 may receive compressed image data, decompress the received image data, store the decompressed data in RAM, and send the data to PWM logic module 107.

Various data and control signal paths may couple PWM logic module 107, driver circuit 108, printhead 109, mechanical controller 123, beam detect sensor 112 and transfer belt position sensor 125. In some embodiments, printhead 109 may be a laser printhead. In some embodiments, beam detect sensor 112 may generate a start of scan (SOS) or “hsync” signal for each scan line in an image, or for a set of scan lines in an image, and send the generated signal to mechanical controller 123, which then sends a signal to PWM logic module 107.

Driver circuit 108 may be communicatively coupled to PWM logic module 107 and printhead 109. In some embodiments, scanning mirror 110 may be mechanically or electromagnetically coupled to scanning motor 111, which may be used to rotate scanning mirror 110. Each laser beam from printhead 109 may be transmitted to scanning mirror 110 and scanning mirror 110 may reflect that beam, at different times, to beam detect sensor 112 and optical system 113, which may include a cylindrical lens, an f-theta lens, a guide lens, and so on. Optical system 113 may guide laser beams from scanning mirror 110 to photosensitive drum 114. Drum charger 116 may be used to charge photosensitive drum 114. Although only one set of scanning mirror 110, scanning motor 111, and beam detect sensor 112 is illustrated in this figure, four sets of the scanning mirror 110, scanning motor 111, and beam detect sensor 112 may respectively be provided for the laser beams. In this case, each beam detect sensor 112 generates an SOS signal.

In some embodiments, latent images from photosensitive drum 114 may be developed with a toner at developing station 115 before transferring to paper 175. Paper 175 may be passed from paper input tray 126 through transfer rollers 124 to transfer belt 117 where toner images developed at developing station 115 and accumulated on transfer belt 117, may be transferred to paper 175. After the image has been transferred, paper 175 may be moved over paper path 118 using transfer rollers 124 and past fuser 119, guide rollers 121, and to paper output tray 122. In some embodiments, fuser 119 may facilitate the fixing of the transferred image to paper 175.

In an exemplary embodiment, printer 100 may include a printer controller 180 and a printer engine 190. Printer controller 180 may be configured to process image data received from computer 200 via connection 120, and send the processed data to print engine 190 for printing. Printer controller 180 of printer 100 may include, among other things, a USB interface 102, a CPU 103, a memory 104, a control block 105, at least one de-compressor module 106 with attached random access memory (“RAM”), at least one pulse width modulation (“PWM”) logic module 107, and at least one driver circuit 108. Exemplary printer engine 190 of printer 100 may include beam detect sensor 112, optical system 113, developing station 115, photosensitive drum 114, drum charger 116, scanning mirror 110, scanning motor 111, and printhead 109. The various modules and subsystems described above may be implemented by hardware, software, or firmware or by various combinations thereof.

In some embodiments, computer 200 may send image data to printer controller 180 over connection 120. The image data sent from the computer 200 may be compressed. In some embodiments, the compressed image data may be in a line-sequential compressed format. After image data is received by USB interface 102, the image data may be placed in memory 104 under the control of CPU 103. In some embodiments, when image data for a complete page has been stored in memory 104, a print sequence may be initiated. In some embodiments, mechanical controller 123 may initiate operations of scanning motor 110, photosensitive drum 114, and transfer belt 117 through appropriate data and/or control signals.

Beam detect sensor 112 can detect a laser beam's position and generate pulses (SOS signals) that are sent to printer controller 180 so that image data can be properly aligned from line to line in a printed image. In some embodiments, at the beginning of a scan of each line of the image, light from the printhead 109 may be reflected by scanning mirror 110 onto beam detect sensor 112. Beam detect sensor 112 may signal mechanical controller 123 which, in turn, may send an SOS signal to PWM logic module 107. In some embodiments, a separate signal typically referred to as top of data (TOD) or “vsync” may also be generated by mechanical controller 123, based on information received from transfer belt position sensor 125. The TOD or vsync signal indicates when image data transfer can begin for paper 175. For example, in some embodiments, a TOD signal may be sent to PWM logic module 107 via mechanical controller 123. Once the TOD signal is received, CPU 103 may initiate a transfer from memory 104 to de-compressor module 106. In some embodiments, de-compressor module 106 may decompress the image data and pass the resulting raw image data to PWM logic module 107. The resultant PWM pulses from PWM logic module 107 may then be streamed to driver circuit 108, which may then transmit the PWM pulses to printhead 109.

In some embodiments, a laser beam from printhead 109 may be modulated and reflected off scanning mirror 110 and optical system 113, causing a latent image of charged and discharged areas to be built up on photosensitive drum 114. In some embodiments, toner develops this latent image at the developing station 115 and the toner image may be transferred to transfer belt 117. For a multi-component image, such as a color image, the latent image building process may repeat for each of the components. For example, for CMYK color printers, which use cyan (“C”), magenta (“M”), yellow (“Y”), and black (“K”), the latent image building process on photosensitive drum 114 may be repeated for each of the colors C, M, Y, and K. Toner images for all four colors may be accumulated on transfer belt 117 before a complete toner image is transferred to the page at transfer roller 124.

In some embodiments, when all components have been assembled on transfer belt 117, paper 175 may be fed from paper input tray 126 to transfer roller 124 where the image may be further transferred to paper 175. Fuser 119 may then fix the toner to paper 175, which is sent to paper output tray 122 using guide rollers 121. In some embodiments, the rate that the images are transferred to paper 175 (i.e., the print speed) may be determined by the rotational speed of transfer belt 117. For example, once the rotational speed is set for the transfer belt 117, the print speed may become constant and any delay in image data transfer to print engine 190 may cause video under-runs and the page may not be printed properly.

A pixel clock generation module (not shown) may be a crystal oscillator or a programmable clock oscillator, or any other appropriate clock generating device. In some embodiments, such as in a “multi-pass” printer 100, which sends the video data for each color serially in sequence, the frequency of the clock generated by the pixel clock generation module may be fixed among each pass of the printer. In an example, multi-pass printer 100, the pixel clock generation module may be a crystal oscillator. In another embodiment, such as a printer 100 that uses multiple sets of printer engine 190, sometimes collectively referred to as a “tandem engine,” the frequency of each channel may be calibrated if the frequencies differ among the pixel clocks corresponding to each of the color components. In such embodiments, one or more programmable clock oscillators may be used to allow calibration.

Exemplary embodiments of printer 100 may include driver circuit 108 driving a printer engine 190, and the driver circuit 108 may be connected to multiple printheads 109. In some embodiments, printheads 109 could all be laser printheads. There may also be a plurality of individual modules of printer controller 180. For example, a single de-compressor module 106 may be connected to multiple PWM logic modules 107 with each PWM module 107 being connected to one or more pixel clock generation modules and one or more driver circuits 108. De-compressor module 106 and attached RAM could provide each PWM logic module 107 with one or more color components of an image, which would then be sent to the multiple driver circuits 108 for onward transmission to printer engine 190.

In other embodiments, multiple de-compressor modules 106 may be coupled to multiple PWM logic modules 107. Each de-compressor module 106 may provide a PWM logic module 107 with a decompressed component of the image. For example, for a multi-component image in CMYK color space, which contains cyan (“C”), magenta (“M”), yellow (“Y”), and black (“K”) image components, each individual image component may be processed by each de-compressor module 106 and sent down to each corresponding PWM logic module 107 in a parallel manner.

In some embodiments, different compression algorithms may be used for the different image components to achieve optimal compression. For example, simple algebraic compression may be used for compressing C, M and K components, and JPEG may be used for compressing the Y component. In some embodiments, the same compression algorithm may be used with different compression parameters for different image components to achieve desired compression ratios. For example, a lower compression ratio of JPEG may be used for compressing C, M and K components, and a higher compression ratio of JPEG may be used for compressing the Y component. A higher compression ratio may reduce the image size more aggressively than a lower compression ratio. Consistent with the present disclosure, compression parameters associated with each compression method used may be determined for each image component in a manner such that the bandwidth of connection 120 is not exceeded, but yet fully used.

In some embodiments, information related to the compression algorithms and parameters used to compress the color data may be transferred to printer 100 via connection 120, along with the compressed color data. De-compressor module 106 may then de-compress each image component with the appropriate de-compression algorithms.

In some embodiments, printer 100 may have multiple lasers per laser printhead 109. In some embodiments, printhead 109 may receive multiple lines of data from driver circuit 108 and project the multiple lines of data to scanning mirror 110. Scanning mirror 110 may then reflect the multiple lines of data to beam detect sensor 112 and optical system 113, which may reflect the multiple lines to photosensitive drum 114. In some embodiments, the beam detect sensor 112 may detect a signal, such as a laser signal, reflected off of the scanning mirror 110, or may also detect multiple signals reflected off scanning mirror 110.

Each of the logical or functional modules described above for printer 100 may comprise multiple modules. The modules may be implemented individually or their functions may be combined with the functions of other modules. Further, each of the modules may be implemented on individual components, or the modules may be implemented as a combination of components.

Exemplary computer 200 may be a computer workstation, desktop computer, laptop computer, or any other computing device capable of being used with printer 100. In some embodiments, exemplary computer 200 may include, among other things, a processor 280, a memory 281, and a USB interface 282. Processor 280 may be a central processing unit (“CPU”). Depending on the type of computer 200 being used, processor 280 may include one or more printed circuit boards, and/or a microprocessor chip. Processor 280 may execute sequences of computer program instructions to perform various processes. The computer program instructions may be accessed and read from memory 281, or any other suitable memory location, and be executed by processor 240. Memory 281 may be any type of Dynamic Random Access Memory (“DRAM”) such as, but not limited to, SDRAM, or RDRAM.

In one exemplary embodiment, a USB interface 282 may be included in computer 200 as an interface to send and receive data via a serial pipe. For example, USB interface 282 may be coupled to processor 280 to receive data to be printed and send the data to printer 100 via connection 120. It is contemplated that other interfaces may also be used to send data via other types of connection 120, such as, for example, parallel port, FIREWIRE or wireless interfaces.

In order to avoid data under-runs on printer 100, a full page of image data can be transferred from computer 200 to printer 100 at a speed higher than or at least equal to the print speed of printer 100. In one embodiment, a color data compression application such as a color data resolution switching application or a color data compression ratio switching application may be included in computer 200. The color data compression application may be used to reduce the size of the color image data so that the image data transfer rate optimally uses available bandwidth of connection 120, while ensuring that the image data transfer rate does not exceed available bandwidth. For example, the color data compression ratio switching application may include a module that determines the optimal compression parameters used for compressing the image data. In some embodiments, the color data compression application may run on computer 200. It is also contemplated that the color data compression application may be stored on a removable computer readable medium, such as a hard drive, computer disk, CD-ROM, DVD ROM, CD±RW or DVD±RW, USB flash drive, memory stick, or any other suitable medium.

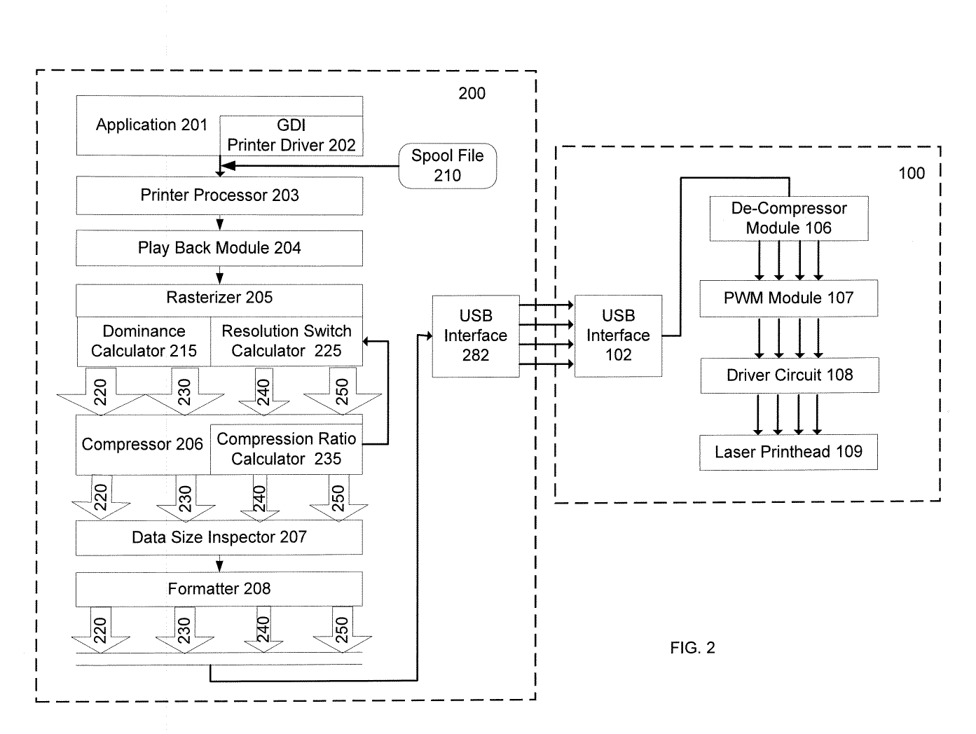

FIG. 2 shows a block diagram indicating an exemplary data flow between an exemplary computer and an exemplary printer for color data compression, according to disclosed embodiments. In an exemplary embodiment, a print job may be initiated by an application 201 running on computer 200. For example, application 201 may use a graphic device interface (“GDI”) and printer driver 202 to generate a description of the print job. The description may include the image data to be printed, such as a letter or a picture, and formatting and printing instructions that form the image data into a properly printed page. In some embodiments, application 201 may use GDI and printer driver 202 to format the description in the form of meta-data and generate a print spool file 210.

The size of the image data may vary depending on the number of color planes associated with the data and the resolution of the image. In some embodiments, the image data may include multiple components associated with multiple color planes. For example, the image may be in a CMYK color space and may contain cyan (“C”), magenta (“M”), yellow (“Y”), and black (“K”) image components. Each image component may be processed and/or transferred one after another, or in a parallel manner. In some embodiments, the formatting and printing instructions may be created and stored as a header in print spool file 210. In some embodiments, the size of the header file may be relatively constant across print jobs.

In some embodiments, generated print spool file 210 may be sent to a printer processor 203 on computer 200. Printer processor 203 may perform tasks such as collating on print spool file 210 before sending print spool file 210 to a playback module 204 for playback. In some embodiments, playback module 204 may create a list of simple objects that can be rasterized by rasterizer 205, based on the GDI description in print spool file 210.

Print spool file 210 may then be sent to a rasterizer 205. Rasterizer 205 may be configured to transform the image data in print spool file 210 into bitmap data. Rasterizer 205 may further include a frame buffer that can contain information related to how pixels will be printed by printer 100 on a print medium. Rasterized bitmap data may be stored in a frame buffer. In some embodiments, rasterizer 205 may transform the image data block by block, when the size of the image data is relatively large. In some embodiments, computer 200 may include a plurality of rasterizers configured to rasterize color data into a plurality of bitmaps. For example, as shown in FIG. 2, rasterizer 205 may be able to rasterize C-plane color data 220, M-plane color data 230, Y-plane color data 240, and K-plane color data 250 in parallel. In some embodiments, rasterizer 205 may include sub-rasterizer modules corresponding to individual color planes, where each sub-rasterizer module may operate on data in its respective color plane.

Consistent with one embodiment of the present disclosure, rasterizer 205 may further include a dominance calculator 215 to determine an order of dominance between a plurality of color planes with respect to an image. A color plane can be considered “dominant” with respect to an image, if the color data in that color plane contributes to the printed color image to a greater degree than data in the other color planes. In some embodiments, dominance may be determined in accordance with the sensitivity of the human eye. Therefore, when viewing an image, the dominant color may evoke greater sensitivity in the human eye. For example, the human eye is less sensitive to yellow. In another example, a more dominant color plane may include denser data than a less dominant color plane in representing the printed image. As a further example, data in a more dominant color plane may have a higher resolution than data in a less dominant color plane.

Various algorithms may be used by dominance calculator 215 to determine the dominance of one color relative to other colors. In some embodiments, an order of dominance between color planes, for an image, may be determined by counting the number of bitmap dots in each color plane and ranking the planes based on the count. For example, a color with the lowest number of bitmap dots may be determined as the least dominant color. In some other embodiments, order of dominance between color planes may also be determined by generating gradation histograms for each color and ranking the colors based on the complexity of the histograms. A gradation histogram may be a histogram chart indicating the distribution of color gradation in an image. For example, complexity of the histogram may be affected by the breadth, number of peaks, and other parameters of the histogram. For an image, the color plane with the simplest gradation histogram may be determined to be the least dominant color plane. For example, the Y-plane may be determined as the least dominant color plane for a CMYK color image. Dominance calculator 215 may assign a number to each color plane indicating its dominance rank among the color planes. For example, a smaller number may be assigned to a less dominant color plane.

Consistent with one embodiment of the present disclosure, rasterizer 205 may be further configured to determine color planes, whose dominance rank is below a pre-determined rank threshold. Rasterizer 205 may then compute two components of the image data for these images. In some embodiments, these components could correspond to a lower resolution image component and a delta image component, for the image data of these color planes. For example, the original color data of a particular color plane in print spool file 201 may have a resolution of 600 dpi. Rasterizer 205 may compute a lower resolution image with a resolution of 480 dpi and a delta image that represents the difference in information between the original image of that plane and the lower resolution image. In some embodiments, the delta image may be removed to reduce the data size of the original color data in print spool file 201. Algorithms such as linear down-sampling may be used to compute the lower resolution image.

In some embodiments, resolution may be reduced in only one physical dimension. For example, resolution may be reduced only in the main scanning direction (i.e., perpendicular to the direction in which paper is fed to a printer). Reducing resolution in the main scanning direction may permit the image data transfer rate to keep up with print speed. For example, if paper is fed to the printer along its length (i.e. vertically) then resolution may be reduced in the horizontal direction. In some embodiments, resolution may be reduced in both dimensions (horizontal and vertical). Various other algorithms may be used to compute the lower resolution image, such as applying low-pass and high-pass filters to the original image.

Consistent with one embodiment of the present disclosure, rasterizer 205 may reduce the image resolution of lower rank color planes more than that of higher rank color planes. Rasterizer 205 may include a resolution switch calculator 225 configured to determine the resolution switch ratios to be used for the lower and higher rank color planes. In some embodiments, resolution switch calculator 225 may determine resolution switch ratios to permit the compressed image of an entire page to optimally use available bandwidth of connection 120. For example, the original color data in print spool file 201 may have a resolution of 600 dpi. Resolution switch calculator 225 may determine a reduced resolution of 540 dpi for the higher rank color planes, and a reduced resolution of 300 dpi for the lower rank color planes. Accordingly, rasterizer 205 may calculate a lower resolution image with a resolution of 540 dpi for higher dominance color data, and a lower resolution image with a resolution of 300 dpi for lower dominance color data. In some embodiments, resolution switch calculator 225 may make its determination on a block by block basis, depending on the size of the buffers in printer controller 180 and/or on the granularity of the resolution switching scheme. For example, for the smallest granularity, the determination may be made on a line by line basis.

Rasterized image data (bitmap data) may be compressed by compressor 206. Compression may reduce the size of the image data, and therefore permit transmission of the compressed image data over connection 120 using the available bandwidth. In some embodiments, compressor 206 may use lossless compression methods such as, for example, JBIG and GIF compressions, so that the image may be perfectly reconstructed by decompression at de-compressor module 106. When lossless compression is used, the image quality may be preserved through the compression and decompression process. However, a high compression ratio cannot always be guaranteed for lossless compressions. For example, images containing high resolution details may not always compress well, i.e., the size of the compressed image may sometimes be comparable to the size of the original image before compression.

In some other embodiments, compressor 206 may use lossy compression methods such as, for example, JPEG and wavelet compressions. Using lossy compression may yield higher compression ratios on average than lossless compression, but exact reconstruction of the original image from the compressed data may not always be achieved. In some embodiments, compressor 206 may also be configured to use a combination of various compression algorithms. For example, compressor 206 may also be configured to use a combination of lossless compression and lossy compression to achieve a balance between image quality and compression ratio.

In some embodiments, computer 200 may include a plurality of compressors configured to compress color data in the color planes. For example, as shown in FIG. 2, compressor 206 may include four sub-compressors for compressing C-plane color data 220, M-plane color data 230, Y-plane color data 240, and K-plane color data 250 in parallel. In some embodiments, the same compression algorithm and parameters may be applied to color data in all the color planes.

In some embodiments, different compression algorithms may be used with different image components to achieve optimal compression. For example, simple algebraic compression may be used to compress color data of higher dominance, and JPEG compression may be used for color data of lower dominance. In some embodiments, the same compression algorithm may be used for different image components, albeit with different compression parameters, to achieve desired compression ratios. A higher compression ratio may reduce an image size more aggressively than a lower compression ratio. For example, the compression ratio can be varied by being more or less aggressive in divisors used for the quantization phase of JPEG compression. Compressor 206 may balance higher compression ratios with consequential degradation in image quality. In some embodiments, a threshold may be set corresponding to the maximum compression ratio that may be used by compressor 206.

In one embodiment, a lower JPEG compression ratio may be used to compress higher dominance color data corresponding to the C, M, and K planes, and a higher compression JPEG ratio may be used to compress lower dominance color data corresponding to the Y-plane. Compressor 206 may include compression ratio calculator 235 configured to determine the compression ratios to be used for the lower and higher rank color planes. Consistent with the present disclosure, compression ratio calculator 235 may determine compression parameters to permit optimal utilization available bandwidth on connection 120. For example, compression ratio calculator 235 may determine compression parameters for the higher rank color planes that may result in a compression ratio of 2, and determine compression parameters for the lower rank color planes that may result in a compression ratio of 10. Accordingly, compressor 206 may compress the color data of each color plane using the determined compression parameters. In some embodiments, compression ratio calculator 235 may also make its determination on a block by block basis, depending on the size of the buffers in printer controller 180 and/or on the granularity of the resolution switching scheme.

Compressed color data may be passed from compressor 206 to a data size inspector 207. Data size inspector 207 may be configured to determine if all bitmap images can be sent across connection 120 without exceeding the available bandwidth of connection 120. In some embodiments, data size inspector 207 may make its determination on a block by block basis, or on a line by line basis. In some embodiments, data size inspector 207 may inspect a block of the original image data and determine the total data size of those portions of compressed color data for each color plane that correspond to the block. Data size inspector 207 may then compare the total data size with a data-size threshold. According to one embodiment, the data-size threshold may be determined based on the print speed of printer 100 and the available bandwidth of connection 120.

In some embodiments, rasterizer 205 and/or compressor 206 may repeat some or all of their operations if data size inspector 207 determines that a block has a data size that is larger than the data-size threshold. Rasterizer 205 may then use resolution switch calculator 225 to re-determine the resolutions for higher dominance and lower dominance data to further reduce the total data size of the compressed color data corresponding to the block. Alternatively or additionally, compressor 206 may use compression ratio calculator 235 to re-determine the compression parameters for higher dominance and lower dominance data to reduce the total data size of the compressed color data corresponding to the block.

Appropriately compressed color data may then be sent from data size inspector 207 to a formatter 208. Formatter 208 may be configured to accumulate one full image in memory. Formatter 208 may provide the accumulated full image to USB interface 282 which transfers the image to printer 100.

USB interface 282 of computer 200 may transfer buffered image data in a compressed form to USB interface 102 of printer 100 via connection 120. Note that the use of a USB interface is exemplary only, and that any other interface/connection combination where an estimate of available bandwidth can be obtained may be used. In some embodiments, USB interface 282 may also transfer information related to the compression algorithms and parameters used by compressor 206 to compress the color data to USB interface 102 of printer 100 via connection 120, along with the buffered image. The information may be used later in de-compressor unit 106 on printer 100. In some embodiments, an isochronous mode of transfer may be supported so that a certain amount of bandwidth may be reserved for each C/M/Y/K image component, and data delivery at a corresponding transfer rate may be guaranteed. In some embodiments, the same bandwidth may be reserved for each sub-channel. In some other embodiments, various bandwidths may be reserved for different sub-channels.

In some embodiments, the compressed image data may be decompressed by de-compressor module 106 using de-compression algorithms corresponding to the compression algorithms used by compressor 206. For example, if JBIG compression is used by compressor 206, the JBIG decompression may be used by de-compressor module 106. When a lossy compression is used by compressor 206, de-compression may not exactly reconstruct the image data as in print spool file 210. In some embodiments, different compression algorithms, or different compression parameters for a single compression algorithm may be used for different image components by compressor 206 to achieve desired compression ratios. Accordingly, de-compressor module 106 may de-compress each image component based on algorithms and/or parameters used by compressor 206.

In some embodiments, de-compressor module 106 may send decompressed image data to PWM logic module 107. The resultant PWM pulses from PWM logic module 107 may then be streamed to driver circuit 108, which may then transmit the PWM pulses to printhead 109. In some embodiments, images may be decompressed block-by-block. In one embodiment, a block of decompressed image data may have a different resolution from another block. For example, a block may have a resolution of 480 dpi, while another block may have a resolution of 600 dpi. In some embodiments, PWM logic module 107, therefore, may be constructed to be able to dynamically switch from a high resolution mode (such as for 600-dpi-driving) or a low resolution mode (such for 480-dpi-driving) on a block-by-block basis. Any appropriate conventional method or mechanism may be deployed for switching of the operation mode of PWM logic module.

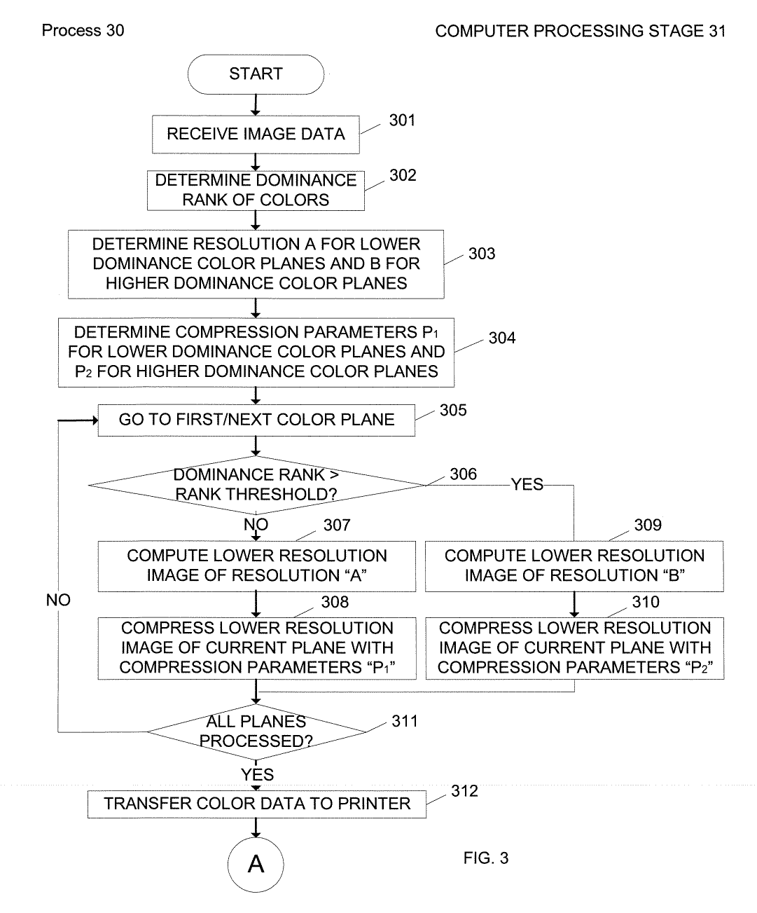

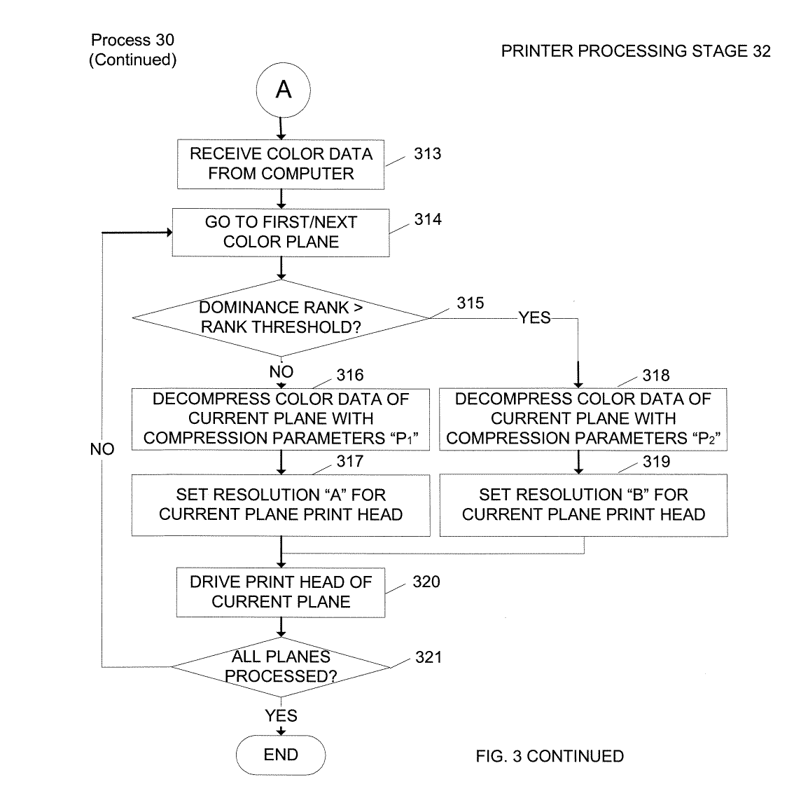

FIG. 3 is a flow chart of an exemplary operation process for color data resolution and compression ratio switching. The algorithm described in FIG. 3 may also be applied to various other types of printing systems such as, for example, copiers and multi-function devices, with appropriate modifications specific to the device and in a manner consistent with embodiments disclosed herein. The algorithm described in FIG. 3 may further be used in conjunction with various software applications to perform resolution and/or compression ratio switching.

In one embodiment, process 30 may include a computer processing stage 31 and a printer processing stage 32. For example, computer processing stage 31 may include steps 301-312. In step 301, image data may be received. For example, application 201 may generate a print spool file 210 that contains print image data and printing instructions, and print spool file 210 may be received by printer processor 203 from application 201. The original image data may have an original resolution, which may be indicated in dots per inch (“dpi”) (e.g., a resolution of 600 dpi). In some embodiments, the image data may include multiple components associated with multiple color planes.

In step 302, based on the image data, an order of dominance between color planes may be determined. For example, dominance calculator 215 may be optionally used to determine the order of dominance. In some embodiments, an order of dominance may be determined by counting the number of bitmap dots for each color and ranking the colors based on the numbers. In some embodiments, order of dominance among color planes may also be determined by generating gradation histograms for each color and ranking the colors based on the complexity of the histograms. As an example, computer 200 may use a CMYK color space which includes a cyan plane, a magenta plane, a yellow plane and a black plane, and the yellow plane may be determined as the least dominant plane. In some embodiments, the order of dominance may be pre-determined and set for printer 100, so that step 302 may be skipped. For example, the yellow plane may be set as the least dominant color plane for a printer 100 that uses CMYK color space.

In some embodiments, a number indicating dominance rank may be assigned to each color to indicate its dominance rank among the polarity of colors. For example, a lower rank may be assigned to a less dominant color. For example, a plane with dominance rank 1 may be the least dominant. In some embodiments, the dominance rank can be an integer varying from 1 to N, where N is the number of color planes. For the purpose of this discussion, a plane with a higher dominance rank is assumed to be more dominant than a plane with a lower dominance rank, and the dominance rank is assumed to be an integer between 1 and the number of color planes. Therefore, in a four-dimensional color space, a color plane with dominance rank 2 is more dominant than a color plane with dominance rank 1, and the color plane with dominance rank 4 is the most dominant. As may be appreciated by one of ordinary skill in the art, the algorithm can easily be modified if a different scheme is used to determine the dominance rank.

In step 303, reduced resolutions may be determined for higher rank color planes and lower color planes, for example, using resolution switch calculator 225. A higher rank color plane may have a dominance rank higher than a rank threshold and a lower rank color plane may have a dominance rank lower than the rank threshold. Color data of higher rank color planes may usually have more higher resolution information to be preserved. Therefore, consistent with one embodiment, resolution switch calculator 225 may determine a lower resolution “A” (i.e., reducing image resolution more aggressively) for lower rank color planes and a higher resolution “B” (i.e., reducing image resolution less aggressively) for higher rank color planes. For example, resolution switch calculator 225 may determine a resolution reduction from 600 dpi to 300 dpi for Y plane and a resolution reduction from 600 dpi to 654 dpi for C, M, and K color planes. In one embodiment, resolution switch calculator 225 may decide not to reduce the resolution for color data of higher rank color planes.

In step 304, compression parameters may be determined for the color planes, for example, using compression ratio calculator 225. In some embodiments, higher compression algorithms may be used for compressing color data of lower dominance to achieve desired compression ratios. Compression ratio may vary among various compression algorithms and/or various parameter sets used for a same compression algorithm. For a given compression method, different compression parameters may correspond to different compression ratios, i.e., how aggressively the image data are compressed.

Color data of lower rank color planes may typically permit higher compression ratios or compressibility. That is, color data in a less dominant plane data may contain relatively lower image-pertinent information. Therefore, consistent with one embodiment, compression ratio calculator 235 may determine a higher compression ratio for lower rank color planes and a lower compression ratio for higher rank color planes. For example, compression ratio calculator 235 may determine a set of compression parameters P₁ for Y plane that compress the color data to half the size, and another set of compression parameters P₂ for C, M, and K color planes that compress the color data to only 1/10.

For certain compression schemes, the compression ratio may have a linear relationship with the compression parameters used. In one embodiment, the color data of the current plane may be compressed by using lower bit depth. For example, color data that are originally represented using 4 bits may be truncated to 2 bits. Accordingly, the size of the color data may be reduced in half (equivalent to a compression ratio of 2). Compression ratio calculator 235 may therefore be able to determine the compression parameters linearly to correspond to the desired compression ratio. However, it should be noted that for many commonly-used compression schemes, the compression ratio achieved with a given set of compression parameters can vary from image to image. Accordingly, no linear relationship may exist between compression parameters and compression ratios.

Consistent with one embodiment, in determining the compression parameters, compression ratio calculator 235 may rely on a look-up table that maps a set of compression parameters to a compression ratio. For example, in DCT-based JPEG compression, the compression ratio may vary according to divisors used in the quantization phase. Accordingly, the look up table may map the divisors to compression ratios. In some embodiments, the look-up table may store divisors or quantization matrices for DCT-based JPEG compression directly. In some embodiments, a representation of the divisors, or quantization matrices may be used. In some embodiments, indirection may be used. For example, look-up table may hold an address to a location where the quantization matrices may be found. Various other methods of implementing the look-up table will be apparent to one of ordinary skill in the art and the methods disclosed may be modified appropriately to operate with these methods.

For wavelet-based JPEG 2000 compression, besides quantization matrices, the choice of wavelets and levels being used in the wavelet transformation may also influence the compression ratio. Accordingly, representations of quantification matrices, wavelets, and levels may be included in the look-up table. In some embodiments, the contents of the look-up table may be determined heuristically. In one embodiment, entries of the look-up table may be generated by running a compression method with a set of compression parameters on a number of experimental images, and using statistical methods to obtain a compression ratio. For example, the average of measured compression ratios obtained for experimental runs may be used to generate the look-up table.

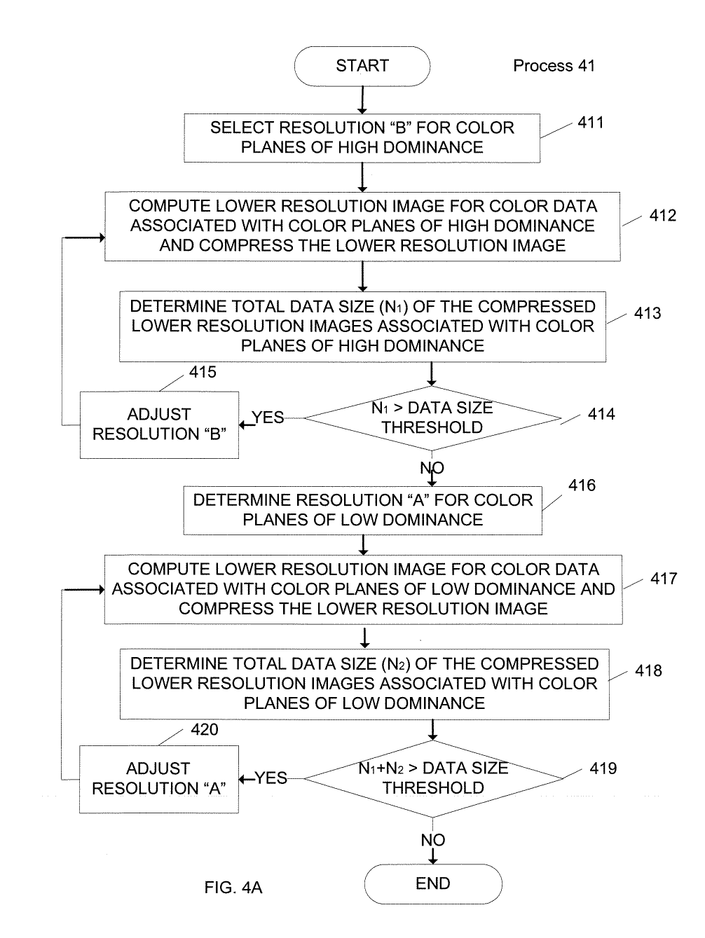

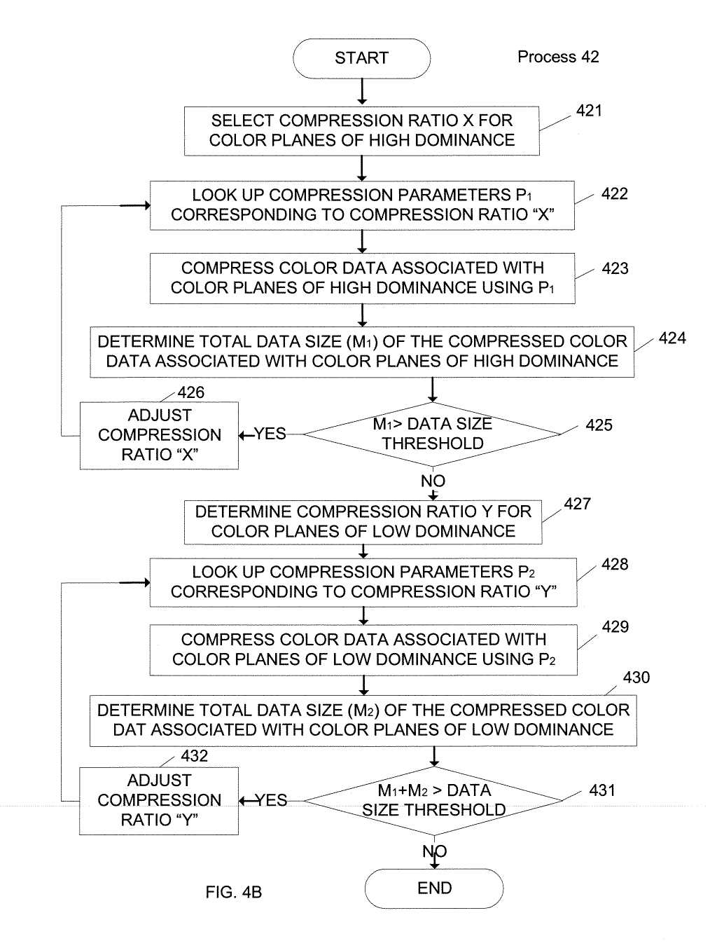

According to one embodiment, steps 303 and 304 may be included in an iterative loop to determine appropriate resolution and compression parameters for each color plane. For example, an iteration may start with a proposed resolution and a set of proposed compression parameters for each color plane. Rasterizer 205 may compute a lower resolution image for the color data according to the proposed resolution. Compressor 206 may compress the lower resolution image according to the proposed compression parameters. Data size inspector 207 may check if the available bandwidth of connection 120 permits transmission of the compressed lower resolution images in the specified timeframe for transmission. A new iterative loop may be started if data size inspector 207 determines that the compression is inadequate. In one embodiment, the look-up table may be automatically updated with compression results obtained during the iterations. Exemplary processes to implement step 303 and step 304 are described in a later part of the disclosure, in connection with FIG. 4A and FIG. 4B.

In step 305, the first or next color plane may be processed. In step 306, the algorithm may determine if the dominance rank of the current color plane exceeds a pre-determined rank threshold. In some embodiments, the rank threshold may be determined based on the print speed of printer 100 and the available bandwidth of connection 120. For example, the rank threshold may be set lower if the available bandwidth of connection 120 is large compared to the size of the print data. In some embodiments, the rank threshold may be set higher than the dominance rank corresponding to the most dominant color so that the rank threshold may not be exceeded by any color plane.

If the dominance rank of the current color plane does not exceed the rank threshold then, in step 307, a lower resolution image may be computed for the current plane color data, according to the resolution “A” determined in step 303. For example, rasterizer 205 may compute the lower resolution image for the image data of the current plane. For example, a lower resolution image with a resolution of 300 dpi may be computed from an original image with a resolution of 600 dpi.

After the lower resolution image is computed in step 307, it may be compressed in step 308 using compression parameters “P₁” determined in step 304. For example, the images may be compressed by compressor 206. Compression may further reduce the size of the images. In some embodiments, the data size of the compressed images may be proportional to the compression ratio. In some embodiments, computer 200 may include a plurality of compressors configured to compress color data of a plurality of color planes. For example, compressor 206 may include four sub-compressors for compressing the C, M, Y, and K data with the different sets of compression parameters as determined in step 304.

In some embodiments, compression parameters corresponding to higher compression ratios may be used for a compression algorithm applied on color data of lower dominance. For example, more aggressive divisors may be used in the quantization phase of JPEG compression to compress the color data of the current plane in step 308. According to an embodiment, for a printer that uses CMYK color space, a higher compression ratio may be used for compressing the Y-plane color data.

In step 306, if the dominance rank of the current color plane exceeds the rank threshold then, in step 309, a lower resolution image may be computed for the current plane color data, according to resolution “A” determined in step 303. For example, rasterizer 205 may compute the lower resolution image for the image data of the current plane. For example, a lower resolution image with a resolution of 540 dpi may be computed from an original image with a resolution of 600 dpi. After the lower resolution image is computed in step 309, it may be compressed in step 310 using compression parameters “P₂” determined in step 304. For example, the images may be compressed by compressor 206 to further reduce the size of the images.

In step 311, it may be determined whether all the color planes have been processed by the computer. If there is still at least one color plane of the print image left unprocessed, the algorithm may go back to step 305 and process the next color plane. The algorithm can iterate through steps 305-311 until all the color planes have been processed by the computer. In step 312, color data of all the color planes may be transferred to a printer in a compressed format. For example, color data may be transferred from computer 200 to printer 100 via connection 120. In some embodiments, color data of the multiple color planes may be transferred in a parallel manner. In some embodiments, in step 313, information related to resolution switching, such as resolutions “B” and “A” used in steps 307 and 309, and data compression algorithms and parameters “P₁” and “P₂” used to compress the color data in steps 308 and 310 may be transferred to printer 100 via connection 120, along with the compressed color data. For example, the information may be included as a header of the compressed color data.

In some embodiments, computer processing stage 31 may conclude at this point, and printer processing stage 32 may begin at step 313. In some embodiments, printer processing stage 32 may include steps 313-321. In step 314, color data for all the color planes may be received by a printer (e.g., printer 100). In step 314, the first or next color plane may be processed. In step 315, the algorithm may determine if the dominance rank of the current color plane exceeds the pre-determined rank threshold.

If the dominance rank of the current color plane does not exceed the rank threshold, it indicates that compression parameters “P₁” is used in step 308. Accordingly, in step 316, the color data of the current color plane may be de-compressed with compression parameters “P₁”. For example, de-compressor module 106 of printer 100 may select a de-compression algorithm and associated parameters based on the corresponding compression algorithm and/or parameters used by compressor 206 in step 308 for the current color plane. For example, if JBIG compression with compression ratio “X” is achieved in step 308 by using compression parameter P₁, a de-compression ratio “1/X” may be achieved in step 316.

In step 317, a print resolution in the main scan direction may be set for the printhead of the current plane corresponding to resolution B. In some embodiments, printer 100 may use a CMYK color space and printhead 109 may comprise four printheads corresponding to the C, M, Y, and K planes, and the resolution for each printhead may be independently configurable. In step 317, a reduced resolution B may be set for the current color plane.

If the dominance rank of the current color plane exceeds the rank threshold, it indicates that compression parameters “P₂” are used in step 310. Accordingly, in step 318, the color data of the current color plane may be de-compressed with compression parameters “P₂”. For example, if JBIG compression with compression ratio “Y” is achieved in step 310 by using compression parameters “P₂”, a de-compression ratio “1/Y” may be achieved in step 318. In step 319, a print resolution B may be set for the printhead of the current plane.

In step 320, the printhead may be driven to print the color data of the current plane to develop a toner image for the current plane. For example, in printer 100, PWM pulses from PWM logic module 107 may be streamed to driver circuit 108, which may then transmit the PWM pulses to printhead 109. In some embodiments, laser beam from printhead 109 may be modulated and reflected off scanning mirror 110 and optical system 113, causing a latent image of charged and discharged areas to be built up on photosensitive drum 114, and a toner image may be developed based on this latent image at the developing station 115.

In step 321, it may be determined whether all the color planes have been processed by the printer. If there is still at least one color plane of the print image left unprocessed, the algorithm may go back to step 314 and process the next color plane. The algorithm can iterate through steps 314-321 until all the color planes have been processed by the printer, after which printer processing stage 32 may conclude.

FIG. 4A is a flow chart illustrating steps in an exemplary process 41 for determining a reduced resolution. For example, process 41 may be implemented as part of performing step 303 of process 30 as shown in FIG. 3. Consistent with one embodiment, the determination of reduced resolution may be made on a block by block basis. In step 411, process 41 may start with selecting a resolution “B” for the higher dominance color planes. The higher dominance color planes may be those that are associated with a dominance rank higher than a rank threshold. Color data associated with higher dominance color planes may usually include high resolution information that needs to be preserved. Therefore, resolution “B” may be input by a user based on his preference, or determined by resolution switch calculator 225 as a relatively high value. In some embodiments, resolution “B” may be close or equal to the original resolution. In some embodiments, an upper limit or threshold on resolution “B” may be specified as some percentage of the available bandwidth. The specification of an upper limit or threshold may ensure that adequate bandwidth is available to compress lower resolution planes. Conversely, a lower threshold on resolution “A” may be specified to ensure that the lower dominance color planes are not excessively degraded.

In step 412, the lower resolution image associated with the higher dominance color planes may be computed by rasterizer 205 according to the selected resolution “B”, and the lower resolution images may be compressed by compressor 206. When the resolution of an image is reduced, the data size of the image may be proportionally reduced.

In step 413, the total data size N₁ of the compressed lower resolution images associated with color planes of higher dominance may then be determined. For example, data size inspector 207 may determine the data sizes of the lower resolution image in each higher dominance color plane and add them up. In some embodiments, the determination in step 412 may be made on a block by block basis. For example, the images may be separated into blocks. For the smallest granularity, the blocks may correspond to individual lines in an image.

In step 414, the algorithm may determine if the compressed lower resolution images of the higher dominance color planes can be sent across connection 120 without exceeding the bandwidth of connection 120. In some embodiments, the total data size N₁ may be determined by data size inspector 207. The total data size may be compared with some pre-determined data-size threshold. According to one embodiment, the data-size threshold may be determined based on the print speed of printer 100 and the available bandwidth of connection 120.

In step 414, if the data size N₁ exceeds the data-size threshold, process 41 may go to step 415 where resolution “B” may be adjusted by a small value. Various algorithms may be used to adjust resolution “B”. For example, resolution “B” may be reduced by a small constant number each time, such as 10 dpi. Alternatively, the adjustment may be determined proportionally to the difference between the total data size and the data-size threshold. It is contemplated that other more sophisticated and more effective algorithms may be implemented in step 415, such as conjugate gradient, fastest gradient descent, etc.

Steps 412-415 may be repeated iteratively until the total data size falls below the data-size threshold. The initial choice for resolution “B” and the quantum of adjustment performed for each iteration may affect speed at which process 41 converges. Convergence relates to the number of iterations over which “B” is adjusted before it reaches its optimal value. Once the data size falls below the data-size threshold in step 414, process 41 may proceed to step 416.

In step 416, a resolution “A” may be determined for lower dominance color planes. Lower dominance color planes may be those that are associated with a dominance rank equal to or lower than the rank threshold. In one embodiment, resolution “A” may be selected to be the same as resolution “B” initially. In another embodiment, resolution “A” may be determined closer to its optimal value by resolution switch calculator 225. For example, based on N₁, resolution switch calculator 225 may calculate the bandwidth available to compressed lower resolution images of lower dominance color planes. Accordingly, bandwidth available for color data of lower dominance color planes may be determined by subtracting N₁ from the available bandwidth across connection 120. Resolution “A” may then be roughly determined according to bandwidth available for color data of lower dominance color planes.

In step 417, the lower resolution image associated with the lower dominance color planes may be computed by rasterizer 205 according to the selected resolution “A”, and the lower resolution images may be compressed by compressor 206. In step 418, the total data size N₂ of the compressed lower resolution images associated with color planes of lower dominance may then be determined.

In step 419, the algorithm may determine if the compressed lower resolution images of all the color planes can be sent across connection 120 without exceeding the bandwidth of connection 120. In some embodiments, the total data size N₁+N₂ may be determined by data size inspector 207. The total data size may be compared with the pre-determined data-size threshold.

In step 419, if the total data size exceeds the data-size threshold, process 41 may go to step 420 where resolution “A” may be adjusted by a small value. The various algorithms that may be used in step 415 may also be used to adjust resolution “A” in step 420. Steps 417-420 may be repeated iteratively until the total data size falls below the data-size threshold. The initial choice for resolution “A” and the quantum of adjustment performed for each iteration may also affect speed at which process 41 converges. Convergence relates to the number of iterations over which “A” is adjusted before it reaches its optimal value. Once the total data size falls below the data-size threshold in step 419, process 41 may conclude.

FIG. 4B is a flow chart of an exemplary operation process 42 for determining compression parameters. For example, process 42 may be implemented for performing step 304 of process 30 as shown in FIG. 3. Consistent with one embodiment, the determination of process may be made on a block by block basis. The algorithm described in FIG. 4B may further be used in conjunction or in combination with the one described in FIG. 4A.

In step 421, process 42 may start with selecting a compression ratio “X” for the higher dominance color planes. The higher dominance color planes may be those that are associated with a dominance rank higher than a rank threshold. For images that include much high resolution information, aggressive compression may usually result in the loss of such high resolution information. Therefore, resolution “X” may be input by a user based on his preference to preserve resolution in the higher dominance color planes, or determined by resolution switch calculator 225 as a relatively low number.

In step 422, a set of compression parameters P₁ corresponding to the compression ratio “X” may be looked up from a look-up table by compression ratio calculator 235. The look-up table may map compression parameters to different compression ratios. For example, in DCT-based JPEG compression, the compression ratio may vary according to divisors used in the quantization phase. Accordingly, the look-up table may map the divisors to compression ratios.

In some embodiments, the look-up table may store divisors or quantization matrices for DCT-based JPEG compression directly. In some embodiments, a representation of the divisors, or quantization may be used. In some embodiments, indirection may be used. For example, look-up table may hold an address to a location where the quantization matrices may be found. For wavelet-based JPEG 2000 compression, besides quantization matrices, the choice of wavelets and levels being used in the wavelet transformation may also influence the compression ratio. Accordingly, representations of quantification matrices, wavelets, and levels may be included in the look-up table. Various other methods of implementing the look-up table will be apparent to one of ordinary skill in the art and the methods disclosed may be modified appropriately to operate with these methods.

In one embodiment, the look-up table may be generated by running a compression method on a number of experimental images. For example, several sample images with distinct image characteristics may be selected. These images may be compressed using a compression method with a given set of compression parameters. Statistical methods may then be used to obtain a compression ratio. For example, the average of measured compression ratios obtained for experimental runs may be used to generate the look-up table.

In another embodiment, for compression methods where the compression ratio is fixed for a given set of compression parameters, the look-up table may be constructed by running the compression method on a single sample image. Alternatively, the compression ratio corresponding to a set of compression parameters may also be theoretically determined using mathematical formulae. For example, for schemes where color data of the current plane is compressed by using lower bit depth, size reductions can be proportional to the reduction in bit depth. For example, if color data originally represented using 4 bits is truncated to 2 bits, the size of the 2-bit color data is reduced in half, resulting in a compression ratio of 2.

In step 423, color data associated with the higher dominance color planes may be compressed by compressor 206 according to the set of compression parameters P₁ found in the look-up table. Accordingly, the data size of the image may be proportionally reduced. In some embodiment, in step 423, the actual compression ratio may be calculated. For example, compression ratio calculator 235 may compute the ratio between the data size of the compressed color data and the data size of the original color data. The look-up table may then update compression ratio “X” with the calculated compression ratio, mapping to the set of compression parameters P₁.

In step 424, the total data size M₁ of the compressed color data associated with color planes of higher dominance may then be determined. For example, data size inspector 207 may determine the data sizes of the compressed color data in each higher dominance color plane and add them up.

In step 425, the algorithm may determine if the compressed color data of the higher dominance color planes can be sent across connection 120 without exceeding the bandwidth of connection 120. In some embodiments, the total data size M₁ may be determined by data size inspector 207. M₁ may be compared with the data-size threshold that may be determined based on the print speed of printer 100 and the bandwidth of connection 120.

In step 425, if the data size M₁ exceeds the data-size threshold, process 41 may go to step 426 where compression ratio “X” may be adjusted by a small value. Again, various algorithms may be used to compression ratio “X”. For example, a compression ratio that is listed next to the current one in the look-up table may be selected. Steps 422-426 may be iterated until the data size M₁ falls below the data-size threshold. Once the total data size falls below the data-size threshold in step 425, process 42 may proceed to step 427.

In step 427, a compression ratio “Y” may be determined for the lower dominance color planes. The lower dominance color planes may be those that are associated with a dominance rank lower than or equal to the rank threshold. In one embodiment, compression ratio “Y” may be selected to be the same as compression ratio “X” initially. In another embodiment, compression ratio “Y” may be determined closer to its optimal value by compression ratio calculator 235. For example, based on M₁, compression ratio calculator 235 may calculate the bandwidth available to compressed color data of lower dominance color planes. Accordingly, bandwidth available for color data of lower dominance color planes may be determined by subtracting M₁ from the available bandwidth across connection 120. Compression ratio “Y” may then be roughly determined according to bandwidth available for color data of lower dominance color planes.

In step 428, a set of compression parameters P₂ corresponding to the compression ratio “Y” may be looked up from a look-up table by compression ratio calculator 235. In some embodiment, in step 428, the actual compression ratio may be calculated. For example, compression ratio calculator 235 may compute the ratio between the data size of the compressed color data and the data size of the original color data. The look-up table may then update compression ratio “Y” with the calculated compression ratio, mapping to the set of compression parameters P₂.

In step 429, color data associated with the lower dominance color planes may be computed by compressor 206 according to the set of compression parameters P₂. In step 430, the data size M₂ of the compressed color data associated with color planes of lower dominance may then be determined.

In step 431, the algorithm may determine if the compressed color data of all the color planes can be sent across connection 120 without exceeding the bandwidth of connection 120. In some embodiments, the total data size M₁+M₂ may be determined by data size inspector 207. The total data size may be compared with the data-size threshold that may be determined based on the print speed of printer 100 and the bandwidth of connection 120.

In step 431, if the total data size exceeds the data-size threshold, process 41 may go to step 432 where compression ratio “Y” may be adjusted by a small value. Again, various algorithms may be used to compression ratio “Y”. For example, a compression ratio that is listed next to the current one in the look-up table may be selected. Steps 428-432 may be iterated until the total data size M₁+M₂ falls below the data-size threshold. Once the total data size M₁+M₂ falls below the data-size threshold in step 431, process 42 may conclude.

In some embodiments, a threshold corresponding to the maximum compression ratio permissible may be set for compression of dominant plane data. Conversely, a minimum compression ratio may be set for lower dominant plane data. Further, the methods in FIGS. 4A and 4B may be modified to account for various tradeoffs between resolution and compression that may be effected in accordance with parameters specified for algorithm 300. For example, compression ratios may be varied up to a point, prior to decreasing the resolution.

Other embodiments of the invention will be apparent to those skilled in the art from consideration of the specification and practice of the invention disclosed herein. For example, in some embodiment, the algorithm described in FIG. 4A may also use a look-up table that maps a set of parameters to a reduced resolution. For example, in steps 412 and 417, a set of parameters may be looked up from the look-up date according to resolutions “A” and “B” and use these parameters to compute the low resolution images. Although these parameters may be determined in steps 412 and 417 in real-time, the use of a look-up may further improve the computational efficiency. For example, when linear down-sampling is used to reduce the resolution, the reduced resolution may vary according to a ratio between the original pixel size and targeted pixel size. Accordingly, the look up table may map the original and targeted pixel sizes to the reduced resolution. As another example, when filtering is used to reduce the resolution, the look-up table may map the central frequency and bandwidth to a reduced resolution. In some embodiments, the parameters may stored directly. In some embodiments, a representation of the parameters may be used. In some other embodiments, indirection may be used. For example, look-up table may hold an address to a location where the parameters may be found. Various other methods of implementing the look-up table will be apparent to one of ordinary skill in the art and the methods disclosed may be modified appropriately to operate with these methods.

In some embodiments, the algorithm described in FIG. 4A and the algorithm described in FIG. 4B may be used in accordance with the print image and the color space used by the printer. For example, the exemplary process 41 may be applied to print images that have low resolution data in one or more color planes, while the exemplary process 40 explained in FIG. 4B may be applied to print images that have sparse color data in one or more color planes. In some embodiments, the algorithm described in FIG. 4A and the algorithm described in FIG. 4B can be combined in a way that an optimal pair of resolution and compression ratio may be determined for a particular print task. For example, the exemplary process 42 explained in FIG. 4B may be applied to determine the compression parameters used for lower and higher dominance color planes in steps 412 and 415 of process 41. It is intended that the specification and examples be considered as exemplary only, with a true scope and spirit of the invention being indicated by the following claims.

What is claimed is:

1. A method for reducing data size of at least one bitmap image using a look-up table, wherein the look-up table stores information correlating a plurality of compression ratios to a set of compression parameters and wherein the bitmap image comprises a plurality of image components, each image component associated with a distinct color plane, the method comprising:
ranking the plurality of color planes using a dominance rank, wherein the dominance rank for a color plane is based on image component data associated with the color plane;
associating at least one compression ratio with each color plane based on the dominance rank associated with the color plane;
compressing at least one image component according to the compression ratio associated with the color plane corresponding to the image component using compression parameters obtained from the look-up table; and
iteratively adjusting the compression ratio, until the total data size of the plurality of image components is below a data size threshold.

2. The method of claim 1, wherein compression is performed using at least one of the following methods:
resolution reduction;
bit depth truncating;
JPEG compression; and
JBIG compression.

3. The method of claim 1, wherein iteratively adjusting the compression ratio further comprises replacing current compression parameters with a second set of parameters corresponding to a higher compression ratio in the look-up table.

4. The method of claim 3, wherein the second set of parameters is obtained by using an immediately higher compression ratio in the look-up table.

5. The method of claim 1, wherein associating at least one compression ratio with each color plane based on the dominance rank associated with the color plane further comprises associating a first data compression ratio with color planes of dominance rank exceeding a rank threshold, and a second data compression ratio with the remaining color planes.

6. The method of claim 1, wherein the compression ratio associated with each color plane bears an inverse relationship to the dominance rank of the color plane.

7. The method of claim 2, wherein the total data size is calculated by summing up the data sizes for each of the at least one compressed image components.

8. The method of claim 5, wherein the first compression ratio is higher than the second compression ratio.

9. The method of claim 1, further comprising updating parameters in the look-up table corresponding to compression ratio using statistical techniques, based on an actual compression ratio obtained using the parameters during each iteration.

10. The method of claim 1, wherein the data size threshold is determined based on at least one of available bandwidth of a communication interface that transfers the compressed image components and a print speed of a printer to which the compressed image components are transferred.

11. A computer-readable medium that contains instructions which, when executed by a processor, performs steps in a method for reducing data size of at least one bitmap image using a look-up table, wherein the look-up table stores information correlating a plurality of compression ratios to a set of compression parameters and wherein the bitmap image comprises a plurality of image components, each image component associated with a distinct color plane, the method comprising:
ranking the plurality of color planes using a dominance rank, wherein the dominance rank for a color plane is based on image component data associated with the color plane;
associating at least one compression ratio with each color plane based on the dominance rank associated with the color plane;
compressing at least one image component according to the compression ratio associated with the color plane corresponding to the image component using compression parameters obtained from the look-up table; and
iteratively adjusting the compression ratio, until the total data size of the plurality of image components is below a data size threshold.

12. The computer-readable medium of claim 11, wherein compression is performed using at least one of the following methods:
resolution reduction;
bit depth truncating;
JPEG compression; and
JBIG compression.

13. The computer-readable medium of claim 11, wherein iteratively adjusting the compression ratio further comprises replacing current compression parameters with a second set of parameters corresponding to a higher compression ratio in the look-up table.

14. The computer-readable medium of claim 11, wherein associating at least one compression ratio with each color plane based on the dominance rank associated with the color plane further comprises associating a first data compression ratio with color planes of dominance rank exceeding a rank threshold, and a second data compression ratio with the remaining color planes.

15. The computer-readable medium of claim 11, wherein the compression ratio associated with each color plane bears an inverse relationship to the dominance rank of the color plane.

16. The computer-readable medium of claim 14, wherein the first compression ratio is higher than the second compression ratio.

17. The computer-readable medium of claim 11, wherein the method further comprises updating parameters in the look-up table corresponding to compression ratio using statistical techniques, based on an actual compression ratio obtained using the parameters during each iteration.

18. The computer-readable medium of claim 11, wherein the data size threshold is determined based on at least one of available bandwidth of a communication interface that transfers the compressed image components and a print speed of a printer to which the compressed image components are transferred.

19. A system method for reducing data size of at least one bitmap image using a look-up table, wherein the look-up table stores information correlating a plurality of compression ratios to a set of compression parameters and wherein the bitmap image comprises a plurality of image components, each image component associated with a distinct color plane, the system comprising:
a dominance calculator configured to rank the plurality of color planes using a dominance rank, wherein the dominance rank for a color plane is based on image component data associated with the color plane;
a compression ratio calculator configured to associate at least one compression ratio with each color plane based on the dominance rank associated with the color plane; and
a compressor configured to compress at least one image component according to the compression ratio associated with the color plane corresponding to the image component using compression parameters obtained from the look-up table;
wherein the compression ratio calculator is further configured to iteratively adjust the compression ratio, until the total data size of the plurality of image components is below a data size threshold.

20. The system of claim 19, wherein the compression ratio calculator being configured to iteratively adjust the compression ratio further comprises the compression ratio calculator being configured to replace current compression parameters with a second set of parameters corresponding to a higher compression ratio in the look-up table.
